(19) United States
(12) Patent Application Publication
(10) Pub. No.: US 2014/0236727 A1
(43) Pub. Date: Aug. 21, 2014

(54) INFORMATION PROVIDING SYSTEM, INFORMATION PROVIDING APPARATUS, AND INFORMATION PROVIDING METHOD

(71) Applicant: YAHOO JAPAN CORPORATION, Tokyo (JP)

(72) Inventor: Yasuhiro SUKEMITSU, Tokyo (JP)

(73) Assignee: YAHOO JAPAN CORPORATION, Tokyo (JP)

(21) Appl. No.: 14/181,027

(22) Filed: Feb. 14, 2014

(30) Foreign Application Priority Data
Feb. 18, 2013 (JP) 2013-029240

(51) Int. Cl. G06Q 30/02

(52) U.S. Cl. CPC G06Q 30/0267; G06Q 30/0261
USPC 705/14.58

(57) ABSTRACT

An information providing system according to an embodiment includes an acquisition unit, a determination unit, a storage unit, and a notification unit. The acquisition unit acquires information on a wireless terminal that enters communication areas of the wireless LAN communication units installed in different. The determination unit determines a movement route of a user of the wireless terminal on the basis of the information on the wireless terminal acquired by the acquisition unit. The storage unit stores the information on the movement route determined by the determination unit as a movement route history. The notification unit notifies the user of the wireless terminal that has entered the communication area of the wireless LAN communication unit of predetermined information on the basis of the movement route history stored in the storage unit.

### CROSS-REFERENCE TO RELATED APPLICATIONS

The present application claims priority to and incorporates by reference the entire contents of Japanese Patent Application No. 2013-029240 filed in Japan on Feb. 18, 2013.

### BACKGROUND OF THE INVENTION

1. Field of the Invention

The present invention relates to an information providing system, an information providing apparatus, and an information providing method.

2. Description of the Related Art

In recent years, an electronic advertising medium called digital signage that displays information distributed through a communication network has been installed in various places such as a store, a street, a station, an airport, and a hotel. For example, an advertiser can display advertisement contents in the digital signage by placing an advertisement through the communication network.

A technology of discriminating a group of gender and a group of age on the basis of face data imaged by a camera, and displaying advertisement contents according to a discrimination result in the digital signage has been proposed (for example, see Japanese Laid-open Patent Publication No. 2012-252613).

However, the technology disclosed in Japanese Laid-open Patent Publication No. 2012-252613 can only display information according to the group of gender and the group of age of a passerby, and may not be able to display information to movement of the passerby in a timely manner because the technology does not take a destination of the movement of the passerby into consideration. This does not only apply to the digital signage, and the same applies to notification of the information to a wireless terminal held by the passerby.

### SUMMARY OF THE INVENTION

According to an exemplary embodiment, an information providing system includes a plurality of wireless LAN communication units, an acquisition unit, a determination unit, a storage unit, and a notification unit. The plurality of wireless LAN communication units are installed in different locations. The acquisition unit acquires information on a wireless terminal that enters communication areas of the plurality of wireless LAN communication units. The determination unit determines a movement route of a user of the wireless terminal on the basis of the information on the wireless terminal acquired by the acquisition unit. The storage unit stores information on the movement route determined by the determination unit as a movement history. The notification unit notifies the user of the wireless terminal that enters the communication area of the wireless LAN communication unit of predetermined information on the basis of the movement history stored in the storage unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1A is a diagram illustrating a configuration example of an information providing system according to an embodiment, FIG. 1B and 1C are explanatory diagrams of a information providing method according to an embodiment;

FIG. 2 is a diagram illustrating an example of a specific configuration of a wireless LAN access point;

FIG. 3A and 3B are diagrams illustrating sequences of establishing sessions between a wireless LAN access point and a wireless terminal;

FIG. 4 is a diagram illustrating an example of a specific configuration of an information providing apparatus;

FIG. 5 is a diagram illustrating an example of detection information data stored in an AP information DB;

FIG. 6 is a diagram illustrating an example of a movement history information table stored in a movement information DB;

FIG. 7 is a diagram illustrating a movement route detected in a movement route detection area;

FIG. 8 is a diagram illustrating an example of a notification information table stored in a notification information DB;

FIG. 9 is a diagram illustrating an example of a route information table stored in a notification information DB;

FIG. 10 is a flowchart of information processing in the wireless LAN access point; and

FIG. 11 is a flowchart of information processing in the information providing apparatus.

### DETAILED DESCRIPTION OF THE PREFERRED EMBODIMENTS

Hereinafter, embodiments of an information providing system, an information providing apparatus, and an information providing method according to the present application will be described in detail with reference to the drawings. Note that the information providing system, the information providing apparatus, and the information providing method according to the present application are not limited by the embodiments.

1. Configuration of Information Providing System

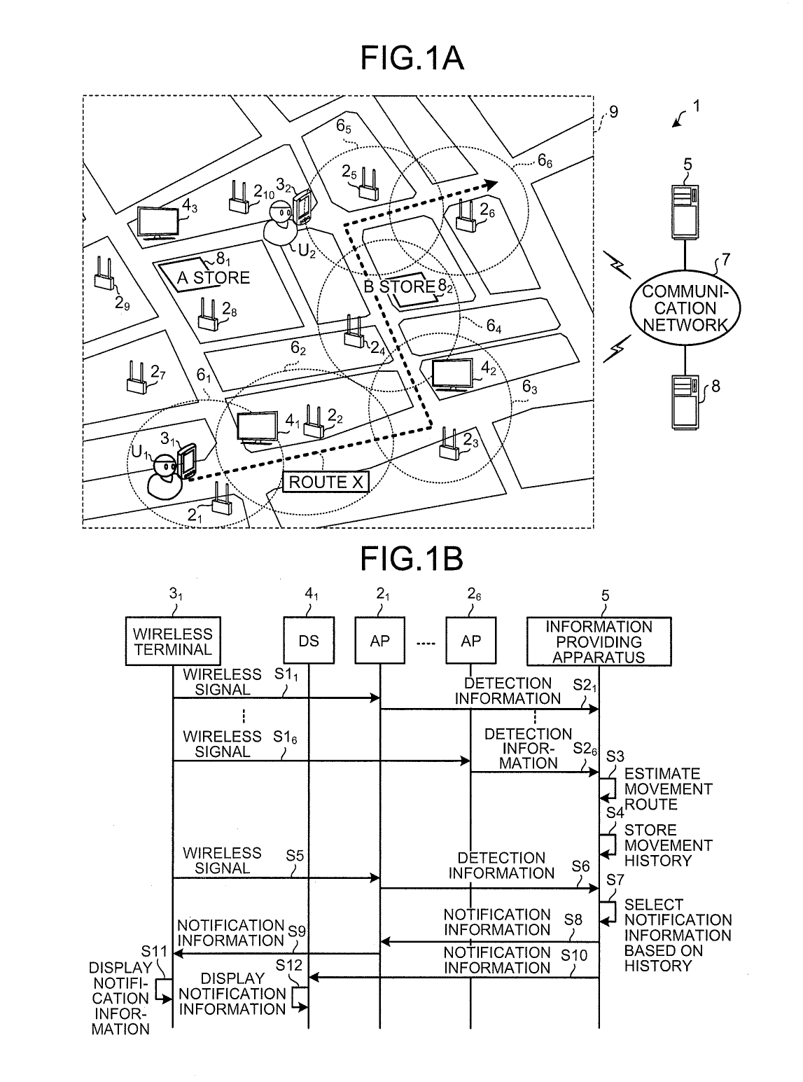

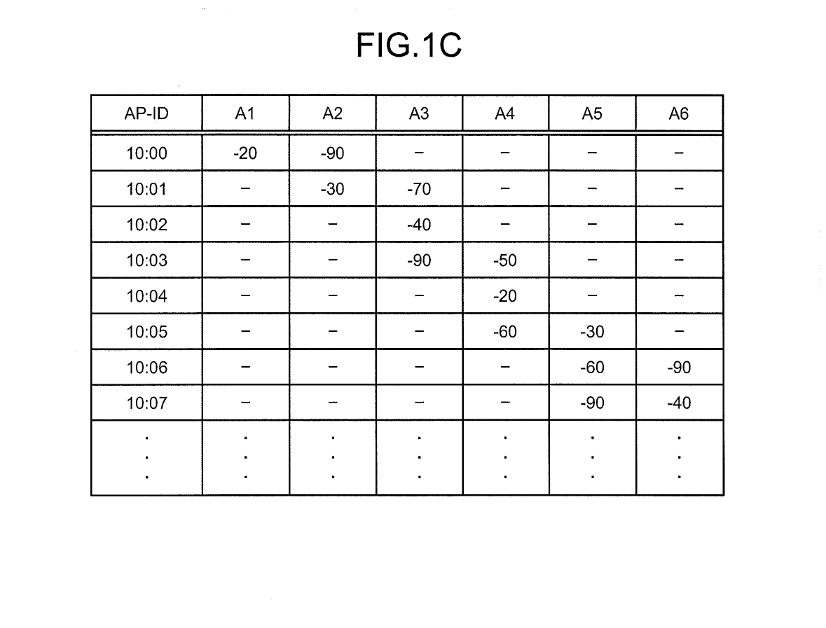

First, a configuration of an information providing system according to an embodiment will be described. FIG. 1A is a diagram illustrating a configuration of an information providing system of an embodiment.

As illustrated in FIG. 1A, an information providing system 1 according to an embodiment includes a plurality of wireless local area network (LAN) access points 2₁ to 2₁₀ (hereinafter, may be collectively referred to as wireless LAN access point 2), digital signages 4₁ to 4₃ (hereinafter, may be collectively referred to as digital signage 4), and an information providing apparatus 5. Note that the number of the wireless LAN access points 2 and the digital signages 4 are not limited to the example illustrated in FIG. 1A.

The wireless LAN access points 2₁ to 2₁₀ covers, as communication areas 6₁ to 6₁₀ (hereinafter, described as AP communication areas 6₁ to 6₁₀), a station, a shopping street, and an event site where concerts and sports are performed, in addition to commercial spaces such as a store, a restaurant, a beauty salon, a barber, a hospital, a movie theater, and a complex leisure facility.

The wireless LAN access point 2 includes a wireless LAN communication unit, and can mutually perform wireless communication with wireless terminals 3₁ and 3₂ by the wireless LAN communication unit. The wireless LAN access points 2₁ to 2₁₀ detect the wireless terminals 3₁ and 3₂ (hereinafter, may be collectively referred to as wireless terminal 3) that have entered the AP communication areas 6₁ to 6₁₀ (hereinafter, may be collectively referred to as AP communication area 6), and transmit information on the wireless terminals 3₁ and 3₂ to the information providing apparatus 5.

The wireless terminals 3₁ and 3₂ are, for example, terminal devices in which a wireless LAN communication function is incorporated, and are, for example, smart phones, tablet PCs (personal computers), game devices, or mobile PCs. For example, the wireless terminals 3₁ and 3₂ can communicate with the information providing apparatus 5, a server device 8 (for example, web server), and the like. Note that, in the example illustrated in FIG. 1A, among the wireless terminals 3₁ to 3ₙ owned by users U₁ to Uₙ (hereinafter, may be collectively referred to as user U), the wireless terminals 3₁ and 3₂ owned by the users U₁ and U₂ are displayed.

The digital signage 4 includes, for example, a display such as a liquid crystal display, a plasma display, or an organic EL display, and a projector. The digital signage 4 includes a wireless/wired LAN communication function, and in a case of through a wireless LAN, for example, the digital signage 4 receives notification information from the information providing apparatus 5 through the wireless LAN access point 2 and displays the notification information. Further, the digital signage 4 can receive the notification information from the information providing apparatus 5 through the wireless LAN access point 2 or another network through the wired LAN and can display the notification information.

The information providing apparatus 5 acquires the information on the wireless terminal 3 through the wireless LAN access point 2 connected to a communication network 7, and determines a movement route of the user U of the wireless terminal 3 on the basis of the acquired information on the wireless terminal 3. The information providing apparatus 5 then stores information on the determined movement route in a storage unit as movement history.

The information providing apparatus 5 notifies the user U of the wireless terminal 3 that has entered the AP communication area 6 of the wireless LAN access point 2 of the notification information on the basis of the movement history stored in the storage unit. Information notification to the user U of the wireless terminal 3 is performed such that the notification information is displayed in the digital signage 4 provided on a route in which the user U of the wireless terminal 3 moves, or the notification information is displayed in a display unit of the wireless terminal 3. Accordingly, the information can be provided to the movement of the user U of the wireless terminal 3 that is a passerby in a timely manner.

FIG. 1B is an explanatory diagram of an information providing method according to an embodiment. As illustrated in FIG. 1A, when the user U of the wireless terminal 3 moves in an area 9 (hereinafter, described as movement route detection area 9) in which the wireless LAN access point 2 is installed, information on the wireless terminal 3 is detected by the wireless LAN access point 2, and the information is transmitted to the information providing apparatus 5.

For example, when a user U₁ of the wireless terminal 3₁ moves in a route X, a wireless signal from the wireless terminal 3₁ is detected by the wireless LAN access points 2₁ to 2₆ (steps S1₁ to S1₆), the information on the detected wireless terminal 3₁ is transmitted to the information providing apparatus 5 from the wireless LAN access points 2, to 2₆ as detection information (steps S2, to S2₆).

The information providing apparatus 5 determines a movement route of the user U, of the wireless terminal 3, on the basis of the detection information acquired from the wireless LAN access points 2, to 2₆ (step S3). The detection information includes, for example, information on radio wave intensity, a terminal ID, and a detection time. The radio wave intensity is radio wave intensity of a wireless signal of the wireless terminal 3, detected in the wireless LAN access points 2, to 2₆, and the terminal ID is identification information of the wireless terminal 3₁. The detection time is a time at which the wireless LAN access points 2, to 2₆ have detected the wireless terminal 3₁.

The information providing apparatus 5 identifies the wireless terminal 3₁ by the wireless ID of the wireless terminal 3₁, and determines the movement route of the user U₁ of the wireless terminal 3, on the basis of the radio wave intensity and the detection time of the wireless terminal 3₁, for example. FIG. 1C is a diagram illustrating a relationship between the radio wave intensity and the detection time of the wireless terminal 3, in the wireless LAN access points 2₁ to 2₆ when the user U₁ of the wireless terminal 3, moves in the route X.

The information providing apparatus 5 includes reference information of the route X learned in advance, for example, and compares the reference information and the information acquired from the wireless LAN access points 2₁ to 2₆ to determine whether the user U₁ of the wireless terminal 3₁ moves in the route X. The reference information of the route X is information indicating a relationship between the radio wave intensity and the detection time of a reference terminal in the wireless LAN access points 2₁ to 2₆ acquired in advance by moving the reference terminal having a wireless LAN function along the route X in advance, for example.

When having determined the movement route of the user U₁, the information providing apparatus 5 stores a determination result in an internal storage unit as information on a movement history (step S4). Similarly, the information providing apparatus 5 determines the movement route of the user U of another wireless terminal 3 that has entered the movement route detection area 9, and stores a determination result in the internal storage unit as information on the movement history.

Following that, when the user U₁ of the wireless terminal 3₁ has entered the movement route detection area 9 again and the wireless signal of the wireless terminal 3₁ is detected by the wireless LAN access point 2₁ (step S5), the information on the wireless terminal 3₁ is transmitted from the wireless LAN access point 2₁ to the information providing apparatus 5 as the detection information (step S6).

When having acquired the information on the wireless terminal 3₁ as the detection information, the information providing apparatus 5 selects notification information on the basis of the information on the movement history stored in the internal storage unit (step S7). The information providing apparatus 5 transmits the selected notification information to the wireless LAN access point 2₁ (step S8), and transmits the notification information to the wireless terminal 3₁ through the wireless LAN access point 2₁ (step S9). In addition, the information providing apparatus 5 transmits the selected notification information to the digital signage 4₁ (step S10). Accordingly, the notification information is displayed in a display unit of the wireless terminal 3₁ (step S11), and the notification information is displayed in the digital signage 4₁ (step S12).

In step S7, the information providing apparatus 5 predicts the movement route of the user U₁ that has entered the AP communication area 6 of the wireless LAN access point 2 on the basis of the movement history of the user U₁ stored in the internal storage unit, and transmits information related to a store on the movement route to the wireless terminal 3₁ and the digital signage 4₁ as the notification information, for example.

Here, as the movement history of the user U₁, the route X (see FIG. 1A) is stored, and the information providing apparatus 5 predicts that the movement route of the user U₁ is the route X. The information providing apparatus 5 then transmits the information on the store on the route X (for example, a B store 8₂ illustrated in FIG. 1A) to the wireless terminal 3₁ and the digital signage 4₁ as the notification information. Accordingly, the information on the route predicted that the user U₁ will move can be notified to the user U₁ in a timely manner.

Further, the information providing apparatus 5 can transmit information related to a store (for example, an A store 8₁ illustrated in FIG. 1A) on a route different from the route X to the wireless terminal 3₁ and the digital signage 4₁ as the notification information. Accordingly, the information on the route different from the route predicted that the user U₁ will move can be notified to the user U₁, and the user U₁ can be led to a store on the route different from the route X.

Hereinafter, the wireless LAN access point 2 and the information providing apparatus 5 that configure the information providing system 1 will be described in more detail.

2. Configuration of Wireless LAN Access Point 2

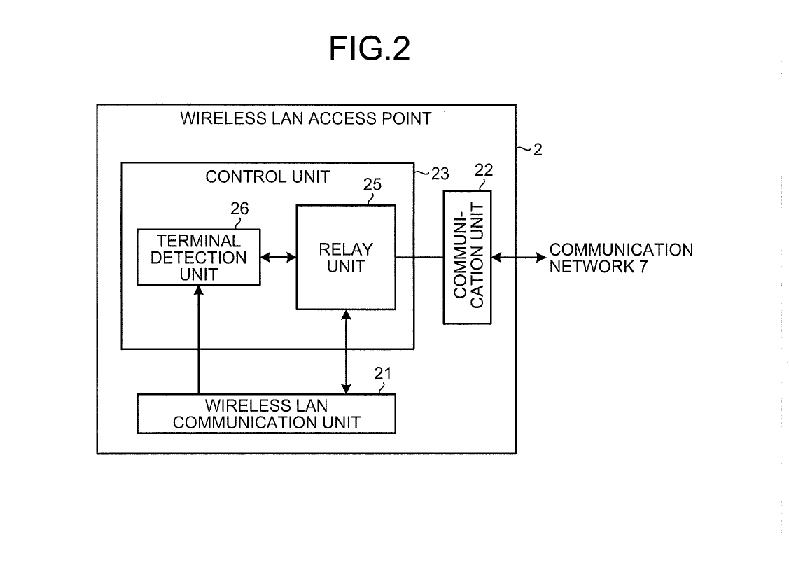

First, a configuration of the wireless LAN access point 2 will be specifically described. As illustrated in FIG. 2, the wireless LAN access point 2 includes a wireless LAN communication unit 21, a communication unit 22, and a control unit 23.

The wireless LAN communication unit 21 is installed such that an area including a target location can be the AP communication area 6. The wireless LAN communication unit 21 is a communication interface that performs wireless LAN communication, and transmits/receives information by wireless signals to/from the wireless terminal 3 in which the wireless LAN communication function is incorporated. Note that an example of the wireless LAN includes a wireless LAN specified by IEEE 802.11. However the wireless LAN is not limited to the wireless LAN of the standard.

The communication unit 22 is connected to the communication network 7, and transmits/receives information to/from a communication network-side device through the communication network 7. The communication unit 22 is connected to the communication network 7 in a wired or wireless manner. The communication network-side device is, for example, the information providing apparatus 5 or a server device 8.

The control unit 23 includes a relay unit 25 that performs information relay processing and a terminal detection unit 26 that performs processing of detecting the wireless terminal 3, and realizes or executes a function or an action of the information processing described below. Note that the internal configuration of the control unit 23 is not limited to the configuration, and may be another configuration as long as the configuration performs the information processing described below.

The relay unit 25 transmits information acquired from the wireless terminal 3 through the wireless LAN communication unit 21 to the communication network-side device from the communication unit 22, and transmits information acquired from the communication network-side device through the communication unit 22 to the wireless terminal 3 from the wireless LAN communication unit 21.

Note that the information transmission from the wireless LAN access point 2 to the communication network-side device is performed by packet communication in which an address of the communication network 7 allocated to the wireless LAN access point 2 is used as a transmission source address, and uses an address of the communication network 7 allocated to the communication network-side device is used as a transmission destination address. The address of the communication network 7 is, for example, an address allocated to the communication unit 22, and is, for example, an IP address.

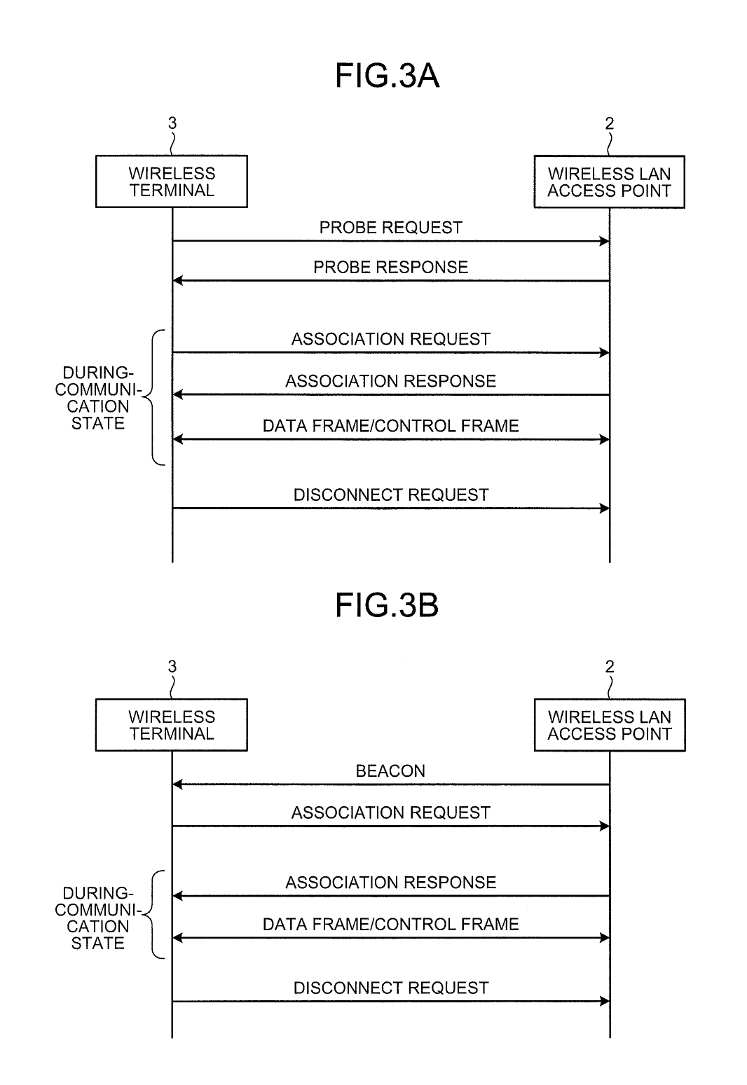

The terminal detection unit 26 acquires a wireless packet transmitted from the wireless terminal 3 through the wireless LAN communication unit 21 to detect existence of the wireless terminal 3. FIGS. 3A and 3B are diagrams illustrating sequences of establishing a session between the wireless LAN access point 2 and the wireless terminal 3.

In the example illustrated in FIG. 3A, a wireless packet called probe request is periodically transmitted from the wireless terminal 3 by broadcast or the like, and the terminal detection unit 26 acquires the wireless packet through the wireless LAN communication unit 21 to detect the existence of the wireless terminal 3.

The probe request includes a basic service set identifier (BSSID), and when the BSSID coincides with a BSSID of the wireless LAN communication unit 21, the terminal detection unit 26 transmits a probe response to the wireless terminal 3. The wireless terminal 3 that has received the probe response moves onto a during-communication state when automatic communication is set.

The moving onto the during-communication state is, as illustrated in FIG. 3A, performed by establishment of a session by an association request and an association response, and following that, the wireless terminal 3 and the wireless LAN communication unit 21 transmit/receive a data frame and a control frame each other to enter the during-communication state.

Further, the terminal detection unit 26 broadcasts a wireless packet called beacon to the wireless terminal 3 to which the wireless packet is not periodically transmitted, through the wireless LAN communication unit 21, as illustrated in FIG. 3B, and receives an association request with respect to the beacon to detect the existence of the wireless terminal 3. The terminal detection unit 26 that has received the association request transmits an association response to the wireless terminal 3 to establish a session, and causes the wireless terminal 3 and the wireless LAN communication unit 21 to be in the during-communication state.

When having moved onto the during-communication state, the terminal detection unit 26 repeatedly receives a wireless packet and detects the existence of the wireless terminal 3 until the during-communication state is cancelled. Note that the during-communication state is cancelled when a disconnect request is given from the wireless terminal 3 or when the wireless packet cannot be transmitted/received between the wireless terminal 3 and the wireless LAN communication unit 21.

When having determined to have detected the wireless terminal 3, for example, the terminal detection unit 26 transmits detection information including terminal information of the wireless terminal 3 from the communication unit 22 to the information providing apparatus 5. To be specific, the terminal detection unit 26 extracts a terminal ID included in the wireless packet transmitted from the wireless terminal 3, and detects radio wave intensity.

The terminal ID is, for example, a MAC address of the wireless LAN communication unit of the wireless terminal 3, and is added to the wireless packet and transmitted from the wireless terminal 3. The radio wave intensity is radio wave intensity of a wireless signal received by the wireless LAN access point 2. Note that the radio wave intensity may be a received signal strength indication (RSSI) acquired in the wireless terminal 3. In this case, the wireless signal including information on the radio wave intensity is transmitted from the wireless terminal 3 to the wireless LAN access point 2.

The terminal detection unit 26 periodically (for example, every second) transmits an AP-ID and information on whether being in the during-communication state in addition to the information on the terminal ID and the radio wave intensity of the wireless terminal 3 to the information providing apparatus 5 as the detection information. As the AP-ID, for example, a network address of the communication network 7 allocated to the communication unit 22 can be used.

3. Configuration of Information Providing Apparatus 5

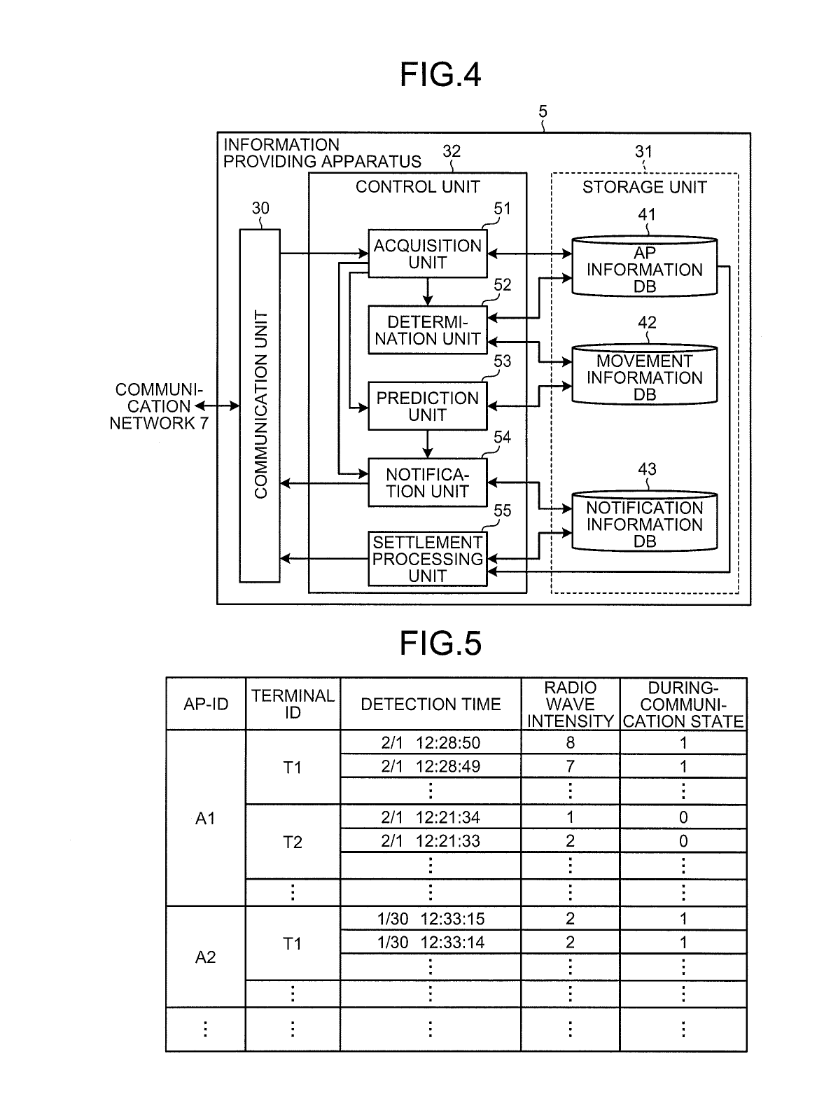

Next, a specific configuration of the information providing apparatus 5 according to the embodiment will be described. FIG. 4 is a diagram illustrating an example of a specific configuration of the information providing apparatus 5 according to the embodiment. As illustrated in FIG. 4, the information providing apparatus 5 includes a communication unit 30, a storage unit 31, and a control unit 32. Further, the storage unit 31 includes an AP information DB 41, a movement information DB 42, and a notification information DB 43, and the control unit 32 includes an acquisition unit 51, a determination unit 52, a prediction unit 53, a notification unit 54, and a settlement processing unit 55.

The communication unit 30 is an interface such as a network interface card (NIC). The control unit 32 transmits/receives various types of information to/from the wireless LAN access point 2, or the wireless terminal 3 through the wireless LAN access point 2, through the communication unit 30 and the communication network 7.

The AP information DB 41, the movement information DB 42, and the notification information DB 43 are storage devices such as hard disks, random access memories (RAM), semiconductor memory devices such as flash memories, or optical disks. Note that the AP information DB 41, the movement information DB 42, and the notification information DB 43 may be a single DB. Note that, while the various IDs stored in the AP information DB 41 and the movement information DB 42 are described using the reference signs “A1” and “T1”, these reference signs are denoted in order to distinguish the IDs for convenience of description, and are not given for the purpose of limiting the IDs.

The control unit 32 is realized, for example, by an integrated circuit such as an application specific integrated circuit (ASIC) or a field programmable gate array (FPGA). Further, a program stored in the internal storage device is executed by a central processing unit (CPU) or a micro processing unit (MPU) using a RAM as a work area, so that the control unit 32 functions as the acquisition unit 51, the determination unit 52, the prediction unit 53, the notification unit 54, and the settlement processing unit 55. Note that the configuration of the control unit 32 is not limited to the configuration, and may be another configuration as long as the configuration performs information processing described below.

3.1. Acquisition Unit 51

The acquisition unit 51 acquires the detection information transmitted from the wireless LAN access point 2, and updates the detection information data in the AP information DB 41 on the basis of the terminal ID, the radio wave intensity, the AP-ID, and the information on whether being in the during-communication state included in the detection information.

FIG. 5 is a diagram illustrating an example of the detection information data. As illustrated in FIG. 5, the detection information data is information in which a “terminal ID”, a “detection time”, “radio wave intensity”, and a “during-communication state” are associated with each other for each “AP-ID”.

The “AP-ID” is identification information of the wireless LAN access point 2 and is information allocated for each wireless LAN access point 2. For example, the “AP-ID” is a network address of the communication network 7 allocated to the communication unit 22 of the wireless LAN access point 2.

The “terminal ID” is identification information of the wireless terminal 3 existing in the AP communication area 6 of the wireless LAN access point 2. For example, the example of FIG. 5 illustrates that the wireless terminals 3₁ and 3₂ of terminal IDs “T1” and “T2”, and the like exist in the AP communication area 6₁ of the wireless LAN access point 2₁ of an AP-ID “A1”.

The “detection time” is information on a time at which the wireless terminal 3 has been detected in the wireless LAN access point 2. For example, when the detection information is transmitted from the wireless LAN access point 2 in cycles of one second, the detection time is set every second, as illustrated in FIG. 5.

The “radio wave intensity” is information on the radio wave intensity of the wireless terminal 3 existing in the AP communication area 6. The example of FIG. 5 illustrates that the radio wave intensity is expressed by an intensity level in which the value becomes larger within a range of 0 to 10 as the intensity becomes higher. However, the radio wave intensity can be set by other units (for example, dBm).

The “during-communication state” is information indicating whether a session has been established between the wireless terminal 3 and the wireless LAN access point 2, and “1” is set when the session has been established, and “0” is set when the session has not been established.

3.2. Determination Unit 52

The determination unit 52 determines a movement route of the user U of the wireless terminal 3 on the basis of the detection information data stored in the AP information DB 41, and sets a determination result to a movement history information table.

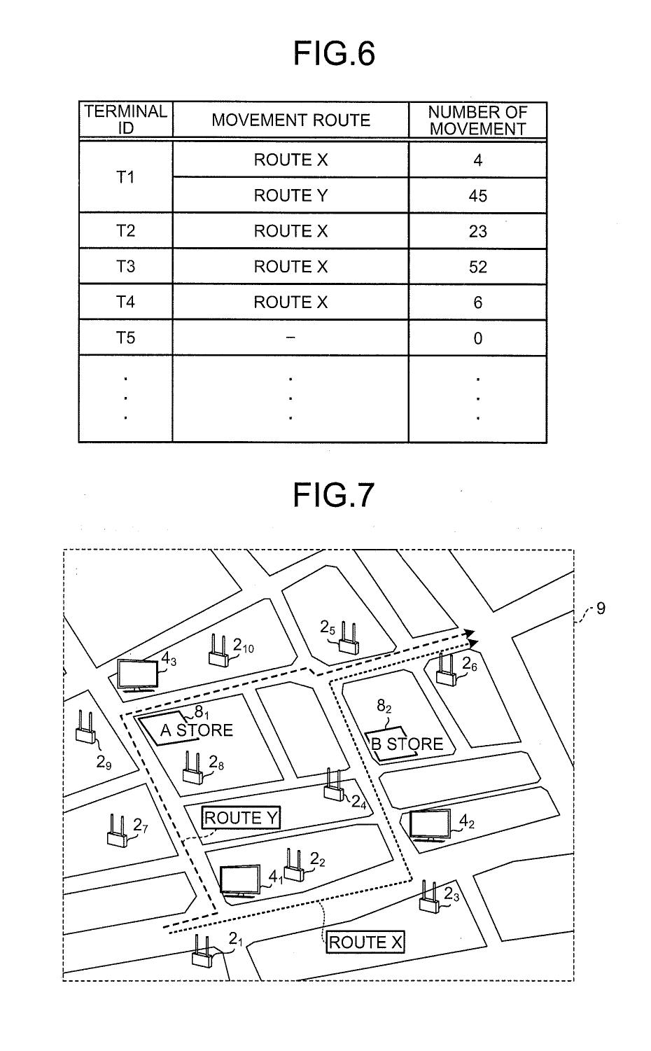

FIG. 6 is a diagram illustrating an example of the movement history information table stored in the movement information DB 42. As illustrated in FIG. 6, the movement history information table is information in which information on the “movement route” and “the number of movement” are associated with each other for each “terminal ID”.

The “terminal ID” is identification information of the wireless terminal 3, and is the same information as the “terminal ID” illustrated in FIG. 5. The “movement route” is information indicating a movement route determined by the determination unit 52, and in the example illustrated in FIG. 6, a route X and a route Y are set. Note that, with respect to a terminal ID “T5” in which the movement route in the movement route detection area 9 has not been determined, the movement route is still not set and the number of movement is set to 0. Note that the wireless terminal 3 in which the movement route in the movement route detection area 9 has not been determined is a wireless terminal 3 that has not entered/has entered the movement route detection area 9 but in which the movement route has not been able to be determined, for example.

FIG. 7 is a diagram illustrating the routes X and Y detected in the movement route detection area 9. As illustrated in FIG. 7, the route X is a route that passes through in front of the digital signages 4₁ and 4₂, and the B store 8₂, and the route Y is a route that passes through in front of the digital signage 4₁, the A store 8₁, and the digital signage 4₃.

The movement history information table illustrated in FIG. 6 illustrates, for example, the user U₁ of the wireless terminal 3₁ of the terminal ID “T1” moves in the route X “four times” and moves in the route Y “45 times” in the movement route detection area 9, and the user U₂ of the wireless terminal 3₂ of the terminal ID “T2” moves in the route X “23 times”.

The determination unit 52 determines the movement route of the user U of the wireless terminal 3 on the basis of the detection information data stored in the AP information DB 41, and updates the movement history information table. Here, the determination unit 52 determines the movement route in either a first determination mode or a second determination mode. Whether which determination mode is used is set by an operator of the information providing system 1, for example.

Reference information is stored in the movement information DB 42 for each of the routes X and Y in advance, and when the first determination mode is set, the determination unit 52 compares the reference information stored in the movement information DB 42 and the detection information acquired from the wireless LAN access point 2 to determine the movement route of the user U.

The reference information is information in which information on the radio wave intensity of the wireless terminal 3 received in each wireless LAN access point 2 is set to each location of the movement route, and the determination unit 52 compares the radio wave intensity and the AP-ID included in the detection information acquired from the wireless LAN access point 2 and the reference information of each movement route in units of the wireless terminal 3, and determines a route in which the degree of similarity is a predetermined value or more to be the movement route of the user U.

When the determination mode is set to the second determination mode, the determination unit 52 estimates the location of the wireless terminal 3 by plotting an estimation result on a virtual map on the basis of the information on the radio wave intensity of the wireless terminal 3 received in the plurality of wireless LAN access points 2, and determines the movement route.

Note that, when the radio wave intensity of the wireless terminal 3 can be received in the plurality of wireless LAN access points 2 at the same timing, the location of the wireless terminal 3 can be estimated. However, when the radio wave intensity of the wireless terminal 3 is received only in one wireless LAN access point 2, the location of the wireless terminal 3 cannot be estimated only from the radio wave intensity. Therefore, the determination unit 52 determines the movement route by interpolating a location that cannot be estimated by the radio wave intensity by the location that was able to be estimated by the radio wave intensity on the basis of the location of the wireless terminal 3 that was able to be estimated by the radio wave intensity.

When having determined the movement route, the determination unit 52 updates the movement history information table. For example, when the movement history information table is in a state illustrated in FIG. 6, and when the determination unit 52 determines the wireless terminal 3₁ of the terminal ID “T1” has passed through the route Y, the determination unit 52 counts up the number of movement corresponding to the route Y to “46”.

Note that the determination of the movement route by the determination unit 52 may just be performed on the basis of the detection information from the wireless LAN access point 2, or may be performed by other methods.

3.3. Prediction Unit 53

When the user U of the wireless terminal 3 has entered the movement route detection area 9, the prediction unit 53 predicts the movement route of the user U having entered the movement route detection area 9 on the basis of the movement history information table stored in the movement information DB 42.

When the history information of the wireless terminal 3 that has entered the movement route detection area 9 (hereinafter, may be described as terminal that has entered the area) has been set to the movement history information table, the prediction unit 53 predicts a movement route in which the user U has moved most frequently as the movement route of the user U that has entered the movement route detection area 9. For example, the user U₁ of the wireless terminal 3₁ of the terminal ID “T1” moves in the route X “four times” and in the route Y “45 times”. Therefore, the prediction unit 53 predicts the movement route of the user U is the route Y.

Further, when the history information of the terminal that has entered the area is not set to the movement history information table, the prediction unit 53 predicts a movement route having a highest probability of most frequently moved as the movement route of the user U that has entered the movement route detection area 9.

For example, assume that the terminal IDs set in the movement history information table illustrated in FIG. 6 are only “T1” to “T5”, and the terminal ID of the terminal that has entered the area is “T5”. In this case, a total number of movement in the route X is “85 (=4+23+52+6) times”, and a total number of movement in the route Y is “45 times”. Therefore, the probability of moving in the route X is about 70% (=85/130), and the probability of moving in the route Y is about 30% (=45/130). The prediction unit 53 predicts the route X having the highest probability of most frequently moved as the movement route of the user U whose history information has not been set to the movement history information table.

3.4. Notification Unit 54

The notification unit 54 notifies the user U of the terminal that has entered the area of the notification information on the basis of the movement route predicted by the prediction unit 53.

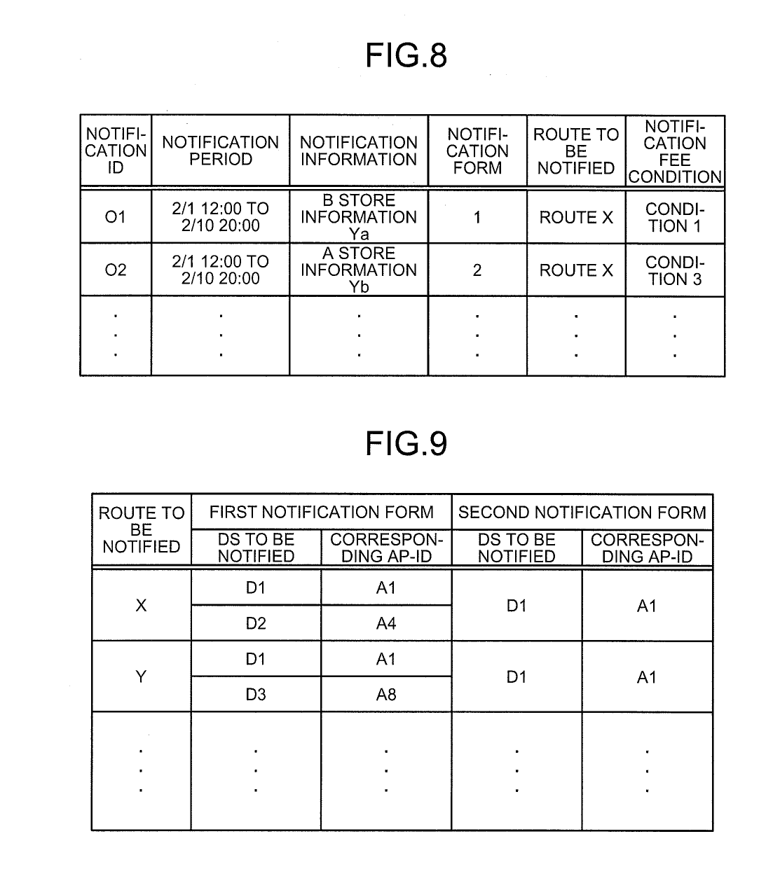

The notification unit 54 selects the notification information from the notification information table stored in the notification information DB 43, and notifies the user U of the notification information. FIG. 8 is a diagram illustrating an example of the notification information table. As illustrated in FIG. 8, the notification information table is information in which a “notification period”, the “notification information”, a “notification form”, a “route to be notified” and a “notification fee condition” are associated with each other for each notification ID.

The “notification ID” is identification information of the notification information. The “notification period” is a period in which the notification information is notified. For example, the notification information of a notification ID “O1” is notified to the terminal that has entered the area that satisfies notification condition during from 12:00 on February 1 to 20:00 on February 10.

The “notification information” is information on advertisement contents to be displayed in the wireless terminal 3 or the digital signage 4, for example, and examples of the advertisement contents include still image data, moving image data, and animation data. Note that the notification information set to the notification information table is data of contents, but may be information indicating a storage location of the advertisement contents in the notification information DB 43.

The “notification form” is information that defines a notification form of the notification information, and “1” is set when the notification form is a first notification form, and “2” is set when the notification form is a second notification form. The first notification form is a method of notifying the notification information in units of the terminal that has entered the area, and the second notification form is a method of notifying the notification information in units of the movement route.

The “route to be notified” is a movement route that is an object of the notification information. For example, regarding the notification information of the notification ID “O1”, when the movement route of the terminal that has entered the area is predicted to be the route X in the prediction unit 53, “B store information Ya” is notified as the notification information to the user U of the terminal that has entered the area.

The notification information includes terminal notification information and signage notification information. The notification unit 54 transmits the terminal notification information to the wireless LAN access point 2 of the AP communication area 6 in which the terminal that has entered the area exists, and notifies the terminal that has entered the area of the terminal notification information through the wireless LAN access point 2. Further, the notification unit 54 transmits the signage notification information to the digital signage 4 and displays the signage notification information in the digital signage 4.

The notification unit 54 determines the digital signage 4 that is a transmission destination of the signage notification information on the basis of the route information table. FIG. 9 is a diagram illustrating an example of the route information table stored in the notification information DB 43.

As illustrated in FIG. 9, the route information table is information in which a “DS to be notified” and a “corresponding AP-ID” are associated with each other for each route to be notified, and the “DS to be notified” and the “corresponding AP-ID” are set for each notification form. When the notification form corresponding to the advertisement ID of the notification information is “1” in the notification information table, the “DS to be notified” and the “corresponding AP-ID” corresponding to the “first notification form” of the route information table are selected. Further, when the notification form corresponding to the advertisement ID of the notification information is “2” in the notification information table, the “DS to be notified” and the “corresponding AP-ID” corresponding to the “second notification form” of the route information table are selected.

The “route to be notified” is the same information as the route to be notified in the notification information table illustrated in FIG. 8, and in the example illustrated in FIG. 9, the route X (see FIG. 7), the route Y (see FIG. 7), and the like are set.

The “DS to be notified” is identification information of the digital signage 4 that serves as the transmission destination of the signage notification information. “D1” is identification information of the digital signage 4₁ (see FIG. 7), “D2” is identification information of the digital signage 4₂ (see FIG. 7), and “D3” is identification information of the digital signage 4₃ (see FIG. 7).

The “corresponding AP-ID” indicates a timing to transmit the signage notification information to the digital signage 4 in which a DS-ID is set to the “DS to be notified”. The notification unit 54 transmits the signage notification information to the digital signage 4 in which the DS-ID is set to the “DS to be notified” at a timing at which the terminal that has entered the area has entered the AP communication area 6 of the wireless LAN access point 2 in which the AP-ID is set to the “corresponding AP-ID”.

Here, processing of notifying the notification information “B store information Ya” of the notification ID “O1” in which “1” is set as the notification form will be described. In the notification information table of FIG. 8, the route X is set as the route to be notified with respect to the notification ID “O1”, and “1” is set as the notification form. Therefore, when there is a wireless terminal 3 estimated to move in the route X by the prediction unit 53, the notification unit 54 acquires the information on the “DS to be notified” and the “corresponding AP-ID” of the “first notification form” corresponding to the route X from the route information table in the notification information DB 43.

The notification unit 54 then transmits the signage notification information included in the “B store information Ya” to the digital signage 4₁ of the DS-ID “D1” on the basis of the information on the “DS to be notified” and the “corresponding AP-ID” at a timing at which the terminal that has entered the area has entered the AP communication area 6₁ of the wireless LAN access point 2₁ of the AP-ID “A1”. In addition, the notification unit 54 transmits the signage notification information included in the “B store information Ya” to the digital signage 4₂ of the DS-ID “D2” at a timing at which the terminal that has entered the area has entered the AP communication area 6₄ of the wireless LAN access point 2₄ of the AP-ID “A4”.

As described above, the notification information in which “1” is set to the notification form is transmitted to and displayed in the digital signage 4 that the terminal that has entered the area has approached. Accordingly, the notification information can be efficiently displayed in the digital signage 4 at a timing at which there is a possibility that the user U of the terminal that has entered the area recognizes the notification information, and the notification information can be notified for each terminal that has entered the area in a timely manner.

Note that the notification unit 54 can transmit the terminal notification information to the terminal that has entered the area through the wireless LAN access point 2 at a timing at which the terminal that has entered the area has entered the wireless LAN access point 2 corresponding to the corresponding AP-ID. This enables the two pieces of notification information: the terminal notification information and the signage notification information to be notified to the user U of the terminal that has entered the area. Therefore, the notification effect can be enhanced.

Note that, as the terminal notification information, information indicating details will be displayed in the digital signage 4 of the DS to be notified and information indicating a location of the digital signage 4 of the DS to be notified can be used. Further, the notification unit 54 transmits the terminal notification information to the terminal that has entered the area, which is in the during-communication state with the wireless LAN access point 2, through the wireless LAN access point 2. However, the notification unit 54 may transmit the notification information to the terminal that has entered the area, which is not in the during-communication state with the wireless LAN access point 2, through another communication route.

For example, when the wireless terminal 3 has a communication unit capable of communicating with a public network such as a telephone communication network or a data communication network, the notification unit 54 can provide the notification information to the terminal that has entered the area, which is not in the during-communication state with the wireless LAN access point 2, by transmitting the notification information to the wireless terminal 3 through the public network.

Next, processing of notifying notification information “A store information Yb” of a notification ID “O2” in which “2” is set as the notification form will be described. In the notification information table of FIG. 8, the route X is set as the route to be notified with respect to the notification ID “O2”, and “2” is set as the notification form. Therefore, the notification unit 54 acquires the information on the “DS to be notified” and the “corresponding AP-ID” of the “second notification form” corresponding to the route X from the route information table in the notification information DB 43.

The notification unit 54 then transmits the signage notification information included in the “A store information Yb” to the digital signage 4₁ of the DS-ID “D1” on the basis of the information on the “DS to be notified” and the “corresponding AP-ID”. The “A store information Yb” is displayed in the digital signage 4₁ of the DS-ID “D1” during the notification period. Note that the notification period is, for example, the period from 12:00 on February 1 to 20:00 on February 10, as illustrated in FIG. 8.

Further, the notification unit 54 transmits the terminal notification information to the terminal that has entered the area through the wireless LAN access point 2₁ at a timing at which the terminal that has entered the area has entered the wireless LAN access point 2₁ corresponding to the corresponding AP-ID “A1”. This enables the two pieces of notification information: the terminal notification information and the signage notification information to be notified to the user U of the terminal that has entered the area. Therefore, the notification effect can be enhanced. Note that, as the terminal notification information, information indicating details will be displayed in the digital signage 4 of the DS to be notified and information indicating a location of the digital signage 4 of the DS to be notified can be used.

Note that the notification unit 54 can transmits the signage notification information or the terminal notification information at different timings instead of the timing at which the terminal that has entered the area has entered the AP communication area 6 of the wireless LAN access point 2 to which the corresponding AP-ID is set.

For example, the notification unit 54 can transmit the signage notification information or the terminal notification information at a timing at which the radio wave intensity or a staying time of the terminal that has entered the area become a predetermined threshold or more in the AP communication area 6 of the wireless LAN access point 2 to which the corresponding AP-ID is set. Alternatively, the notification unit 54 can transmit the signage notification information or the terminal notification information at a timing at which the location of the terminal that has entered the area determined by the determination unit 52 has entered a predetermined location within the AP communication area 6 of the wireless LAN access point 2.

As described above, the notification unit 54 can transmit the signage notification information and the terminal notification information at a notification timing according to the movement route predicted by the prediction unit 53. Therefore, the information can be appropriately provided to the user of the wireless terminal in a timely manner.

Referring back to FIG. 8, description of the notification information table is continued. The “notification fee condition” set to the notification information table is a condition of a value with respect to notification of the notification information, and the fee according to the condition is charged from the operator side of the information providing system 1 to the advertiser that requests the provision of the notification information.

In the “notification fee condition”, any of a “condition 1” to a “condition 3” is set. The “condition 1” is a condition in which the fee is set according to the number of users U of the wireless terminal 3 to which the notification information has been notified, and is an impression type charging condition. When the “condition 1” is set to the “notification fee condition”, and the notification fee per one notification (hereinafter, described as notification unit price) is set to 10 yen, and if the number of the users U of the wireless terminal 3 to which the notification information has been notified is 10,000, 100,000 yen is the notification fee to be billed to the advertiser.

The “condition 2” is a condition in which the fee is set according to the number of users U who have entered a store that is an object of the notification information (hereinafter, described as store to be notified) from among the users U of the wireless terminal 3 to which the notification information has been notified, and is a lead-success type charging condition. For example, in the notification information table illustrate in FIG. 8, the store to be notified of the notification ID “O2” is the A store 8₁, and the fee is set according to the number of the users U who have entered the A store 8₁ after the notification of the notification information.

The “condition 3” is a condition in which the fee is set according to the number of the users U estimated to change the movement route by the notification of the notification information, and is a lead-success type charging condition. For example, assume that the percentage of the user U who passes through the route X is 70%, and the percentage of the user U who passes through the route Y is 30%. In this case, when the percentage of the user U who passes through the route X becomes 64% by the notification of the notification information corresponding to the notification ID “O2”, and the percentage of the user U who passes through the route Y becomes 36%, the percentage of the user U who passes through the route Y becomes 1.2 times. Therefore, for example, the fee according to the number of increased users is set.

3.5. Settlement Processing Unit 55

The settlement processing unit 55 performs charging of the notification fee to the orderer who requested the notification of the notification information in which the notification period has expired. To be specific, the settlement processing unit 55 calculates the notification fee on the basis of the “notification fee condition” set to the notification information table, and transmits information for performing settlement processing of the notification fee to a settlement server (not illustrated) to perform charging of the notification fee to the orderer.

For example, the settlement processing unit 55 calculates the notification fee of the notification information in which the “condition 1” is set as the notification fee condition by multiplying a predetermined notification unit price to the number of the users U of the wireless terminal 3 to which the notification information has been notified.

Further, the settlement processing unit 55 calculates the notification fee of the notification information in which the “condition 2” is set as the notification fee condition by multiplying a predetermined notification unit price to the number of the users U of the wireless terminal 3 who have entered the store to be notified after the notification information was notified. Note that the settlement processing unit 55 determines whether the user U of the wireless terminal 3 has entered the store to be notified on the basis of the detection information data. For example, when the wireless terminal 3 to which the notification information has been notified stays in the AP communication area 6 of the wireless LAN access point 2 corresponding to the store to be notified for a predetermined time or more, the settlement processing unit 55 determines the user U of the wireless terminal 3 has entered the store to be notified.

Further, the settlement processing unit 55 calculates the notification fee of the notification information in which the “condition 3” is set as the notification fee condition by multiplying a predetermined notification unit price to the number of the users U of the wireless terminal 3 estimated to change the movement route.

Note that, in the above description, as the “notification fee condition”, another condition can be set where the “condition 1” to the “condition 3” can be set, or a combination of the “condition 1” to “condition 3” can be set.

4. Processing Flow of Information Providing System 1

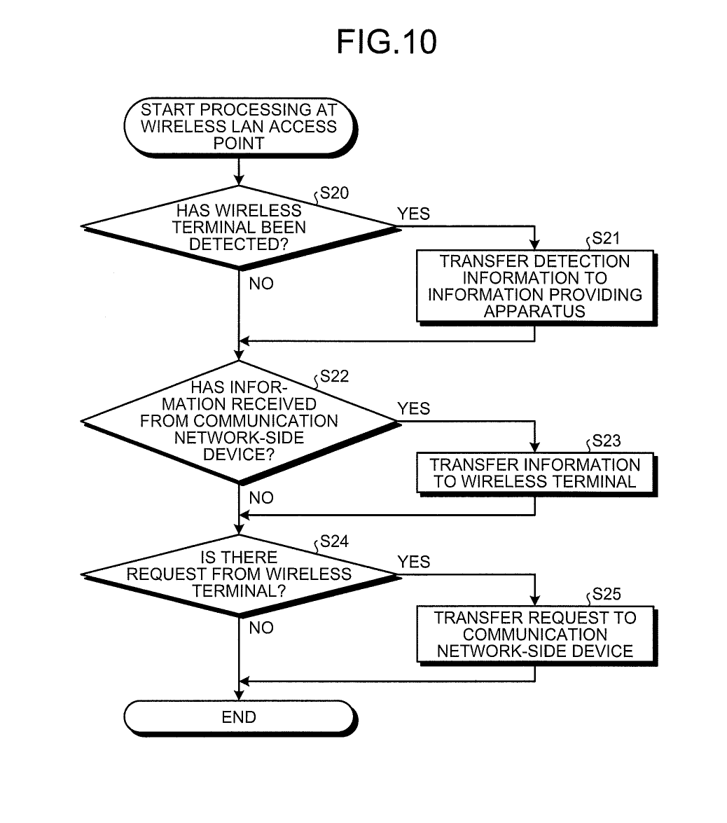

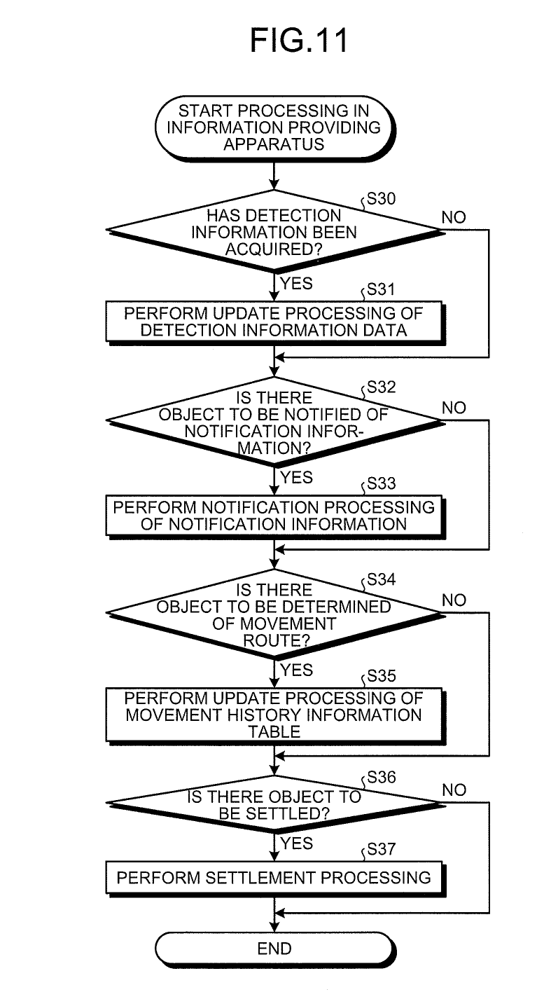

Next, a procedure of information providing process by the information providing system 1 according to the embodiment will be described. FIGS. 10 and 11 are diagrams for describing information providing process flows by the information providing system 1. Hereinafter, processing of the wireless LAN access point 2 will be described with reference to FIG. 10, and processing of the information providing apparatus 5 will be described with reference to FIG. 11.

4.1. Processing Flow of Wireless LAN Access Point 2

First, an example of information processing of the wireless LAN access point 2 according to the embodiment will be described with reference to FIG. 10. FIG. 10 is a flowchart of information processing in the wireless LAN access point 2. The operation is processing repeatedly executed by the control unit 23 of the wireless LAN access point 2.

As illustrated in FIG. 10, the control unit 23 of the wireless LAN access point 2 determines whether having detected the wireless terminal 3 through the wireless LAN communication unit 21 (step S20). In the processing, when having determined to have detected the wireless terminal 3 (Yes in step S20), the control unit 23 transmits the detection information to the information providing apparatus 5 through the communication unit 22 (step S21).

In the processing of step S20, when having determined not to have detected the wireless terminal 3 (No in step S20), or when the processing of step S21 has ended, the control unit 23 determines whether having received the information from the communication network-side device connected to the communication network 7 through the communication unit 22 (step S22). When having determined to have received the information from the communication network-side device (Yes in step S22), the control unit 23 transfers the received information to the wireless terminal 3 that is the destination of the information (step S23).

In step S22, when having determined not to have received the information (No in step S22), or the processing of step S23 has ended, the control unit 23 determines whether there is a request from the wireless terminal 3 to the communication network-side device (step S24). When having determined that there is a request from the wireless terminal 3 to the communication network-side device (Yes in step S24), the control unit 23 transfers the request from the wireless terminal 3 to the communication network-side device to the communication network-side device through the communication unit 22 (step S25).

When the processing of step S25 has ended, or when having determined that there is no request from the wireless terminal 3 to the communication network-side device in step S24 (No in step S24), the control unit 23 terminates the processing.

4.2. Processing Flow of Information Providing Apparatus 5

Next, an example of information processing of the information providing apparatus 5 according to the embodiment will be described with reference to FIG. 11. FIG. 11 is a flowchart of information processing in the information providing apparatus 5. The operation is processing repeatedly executed by the control unit 32 of the information providing apparatus 5.

As illustrated in FIG. 11, the control unit 32 of the information providing apparatus 5 determines whether having acquired the detection information from the wireless LAN access point 2 through the communication unit 30 (step S30). When having determined to have acquired the detection information in the processing (Yes in step S30), the control unit 32 updates the detection information data by adding the acquired detection information to the detection information data (step S31).

When having determined not to have acquired the detection information (No in step S30), or when the processing of step S31 has ended, the control unit 32 determines whether there is an object to which the notification information is to be notified (object to be notified) (step S32). When having determined that there is an object to be notified of the notification information (Yes in step S32), notification processing of transmitting the notification information to the object to be notified is performed (step S33). For example, when the wireless terminal 3 is the object to be notified, the notification information is transmitted to the wireless terminal 3 through the wireless LAN access point 2 of the AP communication area 6 in which the wireless terminal 3 as the object to be notified exists. Further, when the digital signage 4 is the object to be notified, the notification information is transmitted to the digital signage 4 that is the object to be notified.

When having determined that there is no object to be notified of the notification information (No in step S32), or the processing of step S33 has ended, the control unit 32 determines whether there is an object in which the movement route is to be determined (object to be determined) (step S34). When the wireless terminal 3 that entered the movement route detection area 9 has exited from the movement route detection area 9, the control unit 32 determines that there is an object to be determined of the movement route (Yes in step S34), determines the movement route using the wireless terminal 3 that has entered and exited from the movement route detection area 9 as the object to be determined of the movement route, and updates the movement history information table by setting a determination result to the movement history information table (step S35).

When having determined that there is no object to be determined of the movement route (No in step S34), or the processing of step S35 has ended, the control unit 32 determines whether there is an object to which settlement processing is to be performed (object to be settled) (step S36). When having determined that there is an object to be settled in the processing (Yes in step S36), the control unit 32 performs settlement processing (step S37). When having determined that there is no object to be settled (No in step S36), or the processing of step S37 has ended, the control unit 32 terminates the information processing.

5. Modifications

While, in the above described embodiment, the notification information according to the movement route is notified to the user U of the wireless terminal 3, notification information that is different according to a user attribute of the user U (the age, the gender, the address, the liking of the user U, for example) can be notified to the user U of the wireless terminal 3. For example, the notification information is stored in the notification information DB 43 for each user attribute with respect to the movement route in advance, and the notification unit 54 acquires the notification information according to the movement route and the user attribute from the notification information DB 43 and notifies the notification information to the user U of the wireless terminal 3. In doing so, the notification information suitable for the user U can be notified.

Further, while the prediction unit 53 predicts the movement route of the user U that has entered the movement route detection area 9, the notification information that is different according to the degree of certainty of the prediction can be notified to the user U of the wireless terminal 3. For example, the notification information is stored in the notification information DB 43 for each degree of certainty of the movement prediction in advance, and the notification unit 54 acquires the notification information according to the degree of certainty of prediction by the prediction unit 53 from the notification information DB 43 and notifies the notification information to the user U of the wireless terminal 3. In doing so, the notification information suitable for the user U can be notified.

Further, when a plurality of wireless terminal 3 moves in similar locations at the same time, the notification unit 54 may notify different notification information to the digital signage 4. In this case, the notification unit 54 transmits composite notification information obtained by composing a plurality of pieces of notification information to the digital signage 4. The composite notification information is, for example, information for displaying the plurality of pieces of notification information on a display screen of the digital signage 4 at the same time, and is, for example, information for displaying separate pieces of notification information on the right half and left half of the display screen of the digital signage 4, respectively. Further, the composite notification information can be used as the information for displaying the plurality of pieces of notification information on the display screen of the digital signage 4 while switching the plurality of pieces of notification information at predetermined time intervals.

6. Effects

In the information providing system 1 according to the embodiment, the acquisition unit 51 (an example of an acquisition unit) acquires the information on the wireless terminal 3 that has entered the AP communication area 6 of the plurality of wireless LAN access points 2 (an example of a wireless LAN communication unit) installed in different locations each other, the determination unit 52 (an example of a determination unit) determines the movement route of the user U of the wireless terminal 3 on the basis of the information on the wireless terminal 3 acquired by the acquisition unit 51, the movement information DB 42 (an example of a storage unit) stores the information on the movement route determined by the determination unit 52 as the movement history, and the notification unit 54 (an example of a notification unit) notifies the user U of the wireless terminal 3 that has entered the AP communication area 6 of the wireless LAN access point 2 of the notification information (an example of the predetermined information) on the basis of the movement history stored in the movement information DB 42.

With such a configuration, the notification information is notified to the user U of the wireless terminal 3 that has entered the AP communication area 6 of the wireless LAN access point 2. Therefore, the information can be notified in a timely manner, and moreover, effective information provision can be performed by information provision in consideration of the movement history of the user U of the wireless terminal 3.

Further, the prediction unit 53 (an example of a prediction unit) predicts the movement route of the user U of the wireless terminal 3 that has entered the AP communication area 6 of the wireless LAN access point 2 on the basis of the movement history stored in the movement information DB 42, and the notification unit 54 notifies the user U of the wireless terminal 3 of the notification information on the basis of the movement route predicted by the prediction unit 53.

With such a configuration, the information provision is performed from the route predicted that the user U of the wireless terminal 3 will move to the user U of the wireless terminal 3. Therefore, the information can be notified according to the movement of the user U in a timely manner.

Further, the notification unit 54 notifies the user U of the wireless terminal 3 of the information according to the movement route predicted by the prediction unit 53 as the notification information.

With such a configuration, the information on the route predicted that the user U of the wireless terminal 3 will move can be notified to the user U of the wireless terminal 3 in a timely manner.

Further, the notification unit 54 notifies the user U of the wireless terminal 3 of the information related to a store on the movement route predicted by the prediction unit 53 as the notification information.

With such a configuration, the user U of the wireless terminal 3 can be effectively led to the store.

Further, the notification unit 54 notifies the user U of the wireless terminal 3 of the information related to a store on a route different from the movement route predicted by the prediction unit 53 as the notification information.

With such a configuration, the user U of the wireless terminal 3 can be led to a store that originally has no possibility of being dropped by, and a range of customer attraction can be expanded.

Further, the prediction unit 53 predicts the movement route having a highest probability of most frequently moved on the basis of the movement history stored in the movement information DB 42, and the notification unit 54 notifies the user U of the wireless terminal 3 of the information corresponding to the movement route predicted to have a highest probability of most frequently moved by the prediction unit 53 as the notification information.

With such a configuration, for example, even in a region where the user U of the wireless terminal 3 has entered first, the user U can be led to a route having much traffic by notifying the information on a route in which other users U frequently move.

Further, the notification unit 54 notifies the user U of the wireless terminal 3 of the predetermined information at a notification timing according to the movement route predicted by the prediction unit 53.

With such a configuration, the notification information can be provided to the user U of the wireless terminal 3 appropriately and in a timely manner.

Further, the notification unit 54 notifies the user U of the wireless terminal 3 of the notification information by transmitting and displaying the notification information to the digital signage 4 on the movement route of the user U of the wireless terminal 3 that has entered the AP communication area 6 of the wireless LAN access point 2.

With the configuration, the information can be displayed in the digital signage 4 according to the movement of the user U of the wireless terminal 3. Therefore the digital signage 4 can be efficiently used.

In addition, the notification unit 54 notifies the user U of the wireless terminal 3 of the notification information by transmitting and displaying the notification information to the wireless terminal 3 that has entered the AP communication area 6 of the wireless LAN access point 2.

With the configuration, the information can be directly provided to the user U of the wireless terminal 3. Therefore, the notification effect by the notification information can be enhanced.

7. Others

The above-described information providing apparatus 5 may be realized by a plurality of server computers, and the configuration can be flexibly changed depending on a function such that the function is realized by calling an outside platform or the like by an application programming interface (API), network computing, or the like.

According to one aspect of embodiments, the information providing system, the information providing apparatus, and the information providing method capable of providing information to a passerby in a timely manner can be provided.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information providing system comprising:
a plurality of wireless LAN communication units installed in different locations;
an acquisition unit configured to acquire information on a wireless terminal that enters communication areas of the plurality of wireless LAN communication units;
a determination unit configured to determine a movement route of a user of the wireless terminal on the basis of the information on the wireless terminal acquired by the acquisition unit;
a storage unit configured to store information on the movement route determined by the determination unit as a movement history; and
a notification unit configured to notify the user of the wireless terminal that enters the communication area of the wireless LAN communication unit of predetermined information on the basis of the movement history stored in the storage unit.

2. The information providing system according to claim 1, comprising:
a prediction unit configured to predict the movement route of the user of the wireless terminal that enters the communication area of the wireless LAN communication unit on the basis of the movement history stored in the storage unit, wherein
the notification unit notifies the user of the wireless terminal of the predetermined information on the basis of the movement route predicted by the prediction unit.

3. The information providing system according to claim 2, wherein
the notification unit notifies the user of the wireless terminal of information according to the movement route predicted by the prediction unit as the predetermined information.

4. The information providing system according to claim 3, wherein
the notification unit notifies the user of the wireless terminal of information related to a store on the movement route predicted by the prediction unit as the predetermined information.

5. The information providing system according to claim 3, wherein
the notification unit notifies the user of the wireless terminal of information related to a store on a route different from the movement route predicted by the prediction unit as the predetermined information.

6. The information providing system according to claim 2, wherein
the prediction unit predicts a movement route having a highest probability of most frequently moved on the basis of the movement history stored in the storage unit, and
the notification unit notifies the user of the wireless terminal of information corresponding to the movement route predicted to have a highest probability of most frequently moved by the prediction unit as the predetermined information.

7. The information providing system according to claims 2, wherein
the notification unit notifies the user of the wireless terminal of the predetermined information at a notification timing according to the movement route predicted by the prediction unit.

8. The information providing system according to claim 2, wherein
the notification unit performs notification of the predetermined information to the user of the wireless terminal by transmitting and displaying the predetermined information to a digital signage on the movement route of the user of the wireless terminal that enters the communication area of the wireless LAN communication unit.

9. The information providing system according to claim 2,
wherein the notification unit performs notification of the predetermined information to the user of the wireless terminal by transmitting and displaying the predetermined information to the wireless terminal that enters the communication area of the wireless LAN communication unit.

10. An information providing apparatus comprising:
an acquisition unit configured to acquire information on a wireless terminal that enters communication areas of a plurality of wireless LAN communication units installed in different locations;
a determination unit configured to determine a movement route of a user of the wireless terminal on the basis of the information on the wireless terminal acquired by the acquisition unit;
a storage unit configured to store information on the movement route determined by the determination unit as a movement history; and
the notification unit configured to notify the user of the wireless terminal that enters the communication area of the wireless LAN communication unit of predetermined information on the basis of the movement history stored in the storage unit.

11. An information providing method executed by a computer, comprising;
acquiring information on a wireless terminal that enters communication areas of a plurality of wireless LAN communication units installed in different locations;
determining a movement route of a user of the wireless terminal on the basis of the information on the wireless terminal acquired by the acquiring;
storing information on the movement route determined by the determining as a movement history in a storage unit; and
notifying the user of the wireless terminal that enters the communication area of the wireless LAN communication unit of predetermined information on the basis of the movement history stored in the storage unit.
